(19) United States
(12) Patent Application Publication
(10) Pub. No.: US 2025/0331443 A1
(43) Pub. Date: Oct. 30, 2025

(54) SYSTEMS AND METHODS FOR CONTROLLING SPEED OF AN AGRICULTURAL MACHINE

(71) Applicant: Deere & Company, Moline, IL (US)

(72) Inventor: Grant J. Wonderlich, Milan, IL (US)

(73) Assignee: Deere & Company, Moline, IL (US)

(21) Appl. No.: 18/645,716

(22) Filed: Apr. 25, 2024

(51) Int. Cl. A01B 76/00; A01D 69/10

(52) U.S. Cl. CPC A01B 76/00; A01D 69/10

(57) ABSTRACT

One or more techniques and systems are disclosed for controlling a speed of an agricultural machine may comprise determining a mass of a vehicle system of the agricultural machine. The vehicle system may comprise the agricultural machine and one or more of a container and an implement operably connected to the agricultural machine. A controller may calculate a stopping distance of the agricultural machine based on a braking capacity for the agricultural machine and using one or more of a determined dynamically changing mass of the agricultural machine and the dynamically changing brake load of the implement. A maximum speed for the agricultural machine may be determined based on the calculated stopping distance and the speed of the agricultural machine, which may be controlled to be below the maximum speed.

### BACKGROUND

Vehicles, such as agricultural machines, are being designed to operate autonomously. While operating autonomously, speed control and braking function are still needed, for example, to control vehicle train speed, slow the vehicle train, bring the vehicle to a complete stop (as needed) in the work cycle, or when an object is detected near the tractor and/or connected implement. Current speed control and brake architectures are designed to be actuated by an operator sitting in the operator station of the agricultural machine (e.g., cab of the vehicle). In autonomous settings, without additional controls, vehicle speed may have to be limited, thereby affecting productivity.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for speed control of an agricultural machine. In one implementation, a computerized system for controlling a speed of an agricultural machine may comprise a vehicle system and a controller. The vehicle system may comprise one or more of the agricultural machine configured to perform an agricultural field operation and a container and/or an implement operably connected to the agricultural machine. The controller may be configured to determine a mass of the vehicle system at a point in time. The container may comprise the mass that dynamically changes. The implement may comprise a draft load that dynamically changes. The controller may calculate a stopping distance of the agricultural machine based on a braking capacity for the agricultural machine using one or more of the determined mass of the vehicle system and the draft load. The controller determines a maximum speed for the agricultural machine based on the calculated stopping distance. The controller may control the speed of the agricultural machine to be below the maximum speed and/or to provide a recommended speed to an operator.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a diagram illustrating a crop harvesting operation in a field according to an example.

FIG. 2 is a diagram of a harvester vehicle and illustrating crop harvesting according to an example.

FIG. 3A is another diagram illustrating a crop harvesting operation in a field according to an example.

FIG. 3B is an enlarged view of area 3B shown in FIG. 3A.

FIG. 3C is an enlarged view of area 3C shown in FIG. 3C.

FIG. 4 is a block diagram illustrating a speed control system according to one implementation.

FIG. 5 illustrates an example of a method for vehicle speed control according to an implementation.

FIG. 6 is a graph of speed control curves according to an implementation.

FIG. 7 is a block diagram of an electronic control unit usable with one or more implementations.

FIG. 8A is a schematic diagram of a ground engaging implement used in accordance with one of the systems and methods described herein.

FIG. 8B is a schematic diagram of a non-ground engaging implement used in accordance with one of the systems and methods described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form to facilitate describing the claimed subject matter.

The methods and systems disclosed herein, for example, may be suitable for use in controlling speed and managing stopping distances for agricultural machines. In the nonlimiting examples described herein, the method and systems described may be suitable for different harvesters and harvesting applications. That is, the herein disclosed examples can be implemented in different harvesters other than for particular types of crops and/or harvesting systems (e.g., other than for specific combine harvester vehicles for particular harvesting applications, such as for particular grain harvesting) to control movement of harvester vehicles and other vehicles that results in improved performance, such as increased harvested crop throughput.

For example, one or more herein described examples allow for controlling the speed of one or more agricultural machines, including managing the stopping distances of the agricultural machines during crop harvesting, to increase the productivity of the overall harvest system (e.g., to maximize throughput of the harvest system by maintaining an optimized speed for the agricultural machines). That is, one or more examples control the speed of agricultural machines to maintain a specified stopping distance. In some examples, vehicle speed control (using stopping distance determinations) is used in combination with perception systems for autonomous agricultural machines to allow different velocities, while maintaining the stopping capability of the system. Without such control in autonomous systems, speed limits would have to be imposed on systems based upon worst case calculations (e.g., maximum possible stopping distance) thus limiting productivity even when stopping distances can be met. With one or more speed control implementations described herein, any imposed speed limits would not have to be based on worst case calculations. It should be appreciated that the herein described examples can also be used in semi-autonomous and non-autonomous applications as well.

In some implementations, different agricultural machines move within and outside of a field during different operations (e.g., harvesting operations, fertilizing operations, etc.). In one or more examples, the mass (or weight) of the agricultural machines, which can change (e.g., empty grain cart versus filled grain cart) during the operations, is used to control the speed of the agricultural machines, particularly to control the speed of the agricultural machines to be below a defined limit (e.g., predefined maximum limit) to ensure effective stopping distances for the agricultural machines. In some implementations, particularly during autonomous operation of the agricultural machines, the herein described controls allow for increasing or maximizing the productivity of the harvest system when a number of agricultural machines are working together by controlling the speeds of each of the agricultural machines to be close to the determined maximum speed. That is, instead of limiting the speed of the agricultural machines to a value based on the maximum weight of the agricultural machines, one or more examples dynamically adjust the maximum speed based on the mass of the agricultural machines and optionally other factors that can affect braking stopping distances. For example, current data (e.g., vehicle mass, harvesting conditions, etc.) and optionally historical data, as well as one or more characteristics of the agricultural machines, can be used to control the speed of the agricultural machines.

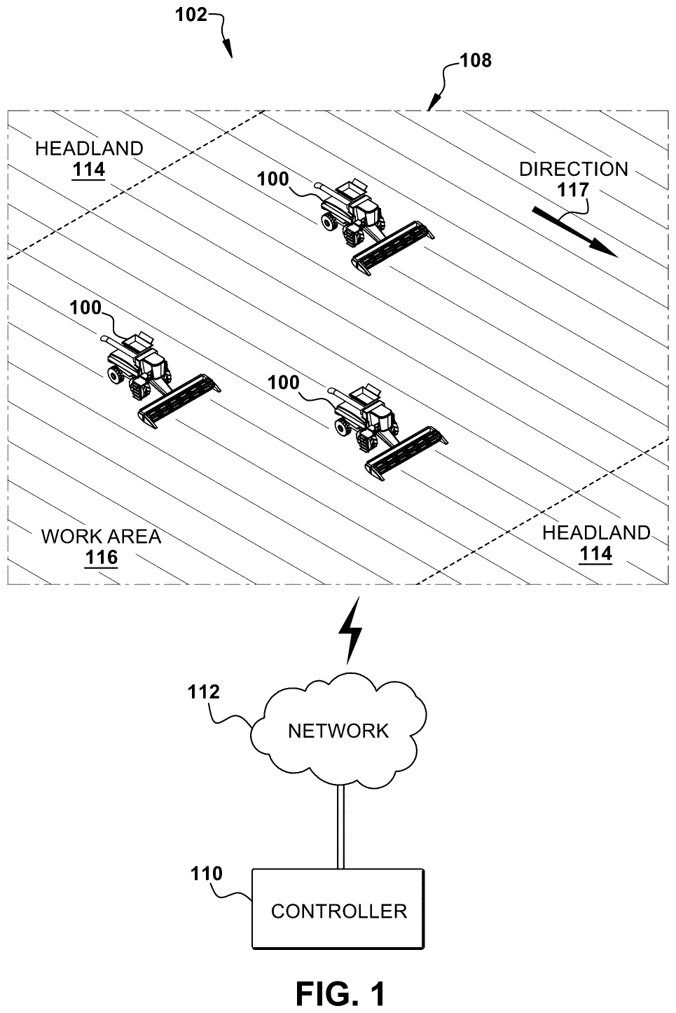

It should be appreciated that one or more examples described herein can be implemented in connection with any type of agricultural application, such as any type of harvesting operations. That is, the present disclosure contemplates systems and arrangements used in processed and/or not processed agricultural environments or applications. FIG. 1 illustrates a work machine 100, for example an agricultural tractor. This disclosure also applies to other types of work vehicles in agriculture, construction, forestry, and road building.

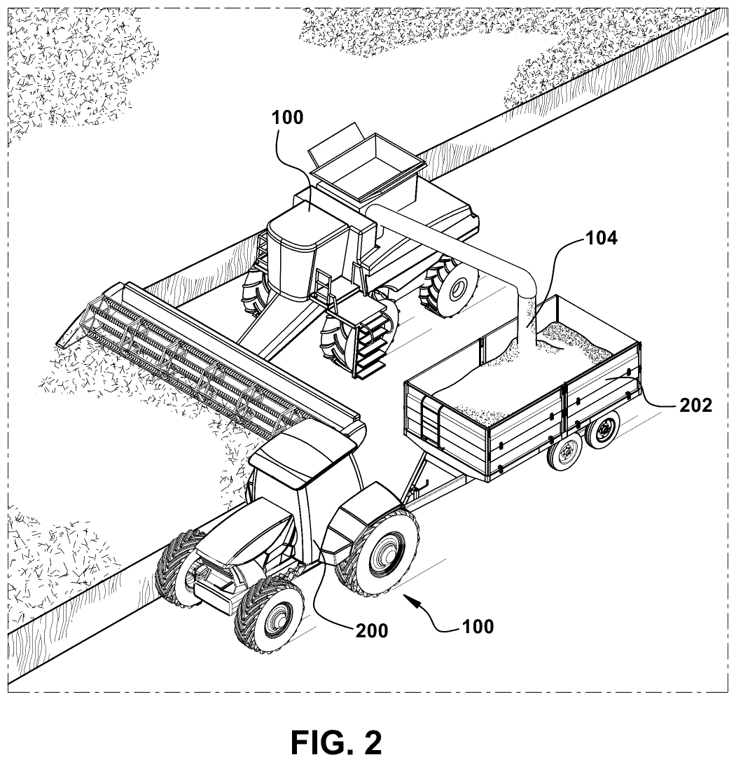

In one or more examples, vehicle movement (i.e. agricultural machine movement) within a field, particularly speed of the vehicles, is controlled using speed control processes as described in more detail herein. For example, as illustrated in FIGS. 1 and 2, a system for controlling a speed of an agricultural machine 100 may comprise a vehicle system 210 and a controller 110. Controlling the speed of the agricultural machine 100 may be, in example implementations, with reference to controlling the speed with the controller for an autonomous agricultural machine or by providing a recommended speed to an operator. The vehicle system 210 may comprise the agricultural machine 100, which is configured to perform an agricultural field operation, and a container 202 operably connected to the agricultural machine. Generally, the controller 110 is configured to receive at least one or more dynamically changing inputs from the vehicle system in order to control the speed of the agricultural machine 100. One of the dynamically changing inputs may be the mass of the vehicle system 210. The controller 110 may be configured to determine the mass of the vehicle system 210 at a point in time. The container 202 may comprise the mass that dynamically changes. The implement may comprise a draft load that dynamically changes. The controller 110 calculates a stopping distance of the agricultural machine 100 based on a braking capacity for the agricultural machine 100 using the determined mass of the vehicle system 210. The controller 110 determines a maximum speed for the agricultural machine 100 based on the calculated stopping distance. The controller 210 may control the speed of the agricultural machine 110 to be below the maximum speed.

In a non-limiting example, the agricultural machine 100 may be a tractor 200, and the container 202 may be a cart 202. Speed control of the tractor 200 and the cart 202 in coordination with one or more harvester vehicles 100 (e.g., combine harvesters) is provided. It should be appreciated that the herein described examples can be used for speed control (and braking control), as well as vehicle movement coordination with any type of vehicle, such as any type of vehicle used during crop harvesting or other field operations, or other non-field operations. Various implementations of the present disclosure may be used for controlling movement of one or more agricultural machines, and work machines generally, including without limitation, agricultural vehicles, harvesters, combines, agricultural equipment, tractors, sprayers, air seeders, planters, mowers, automobiles, trucks, armored vehicles, landmine clearing vehicles, utility vehicles, or any other vehicles intended to provide coverage of a specific land areas. The container 202 may take a variety of forms and may include without limitation, one or more of a grain cart, a grain wagon, a grain tank, a tank, a commodity cart, a commodity tank, an onboard container, and a fuel tank. The control operations can be performed using different controllers, such as in a single computing system or a distributed computing system.

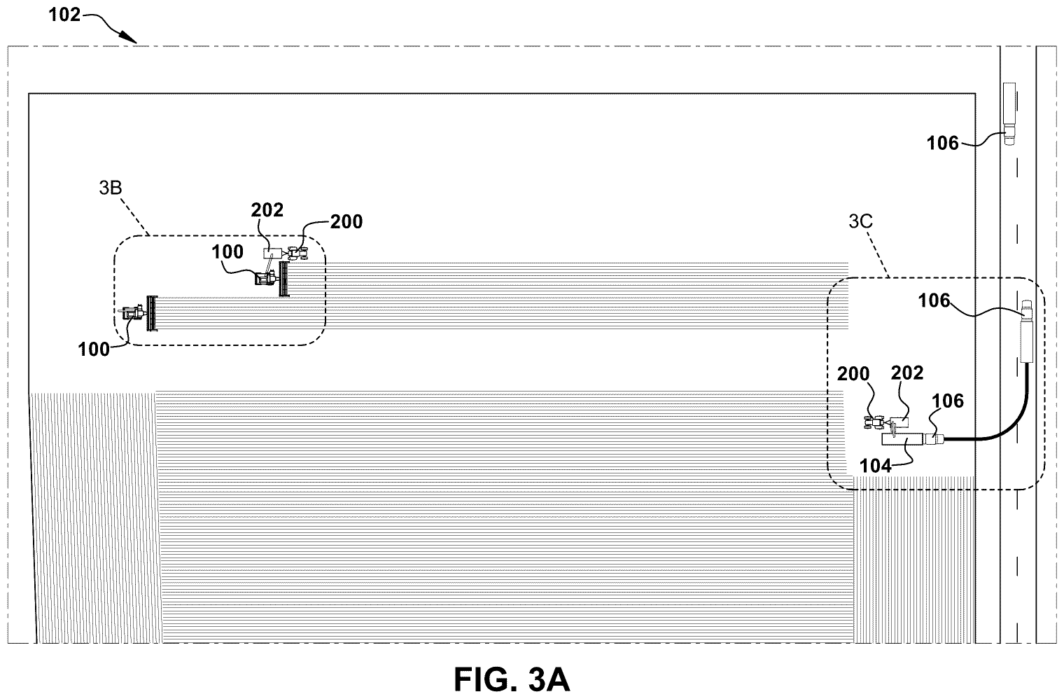

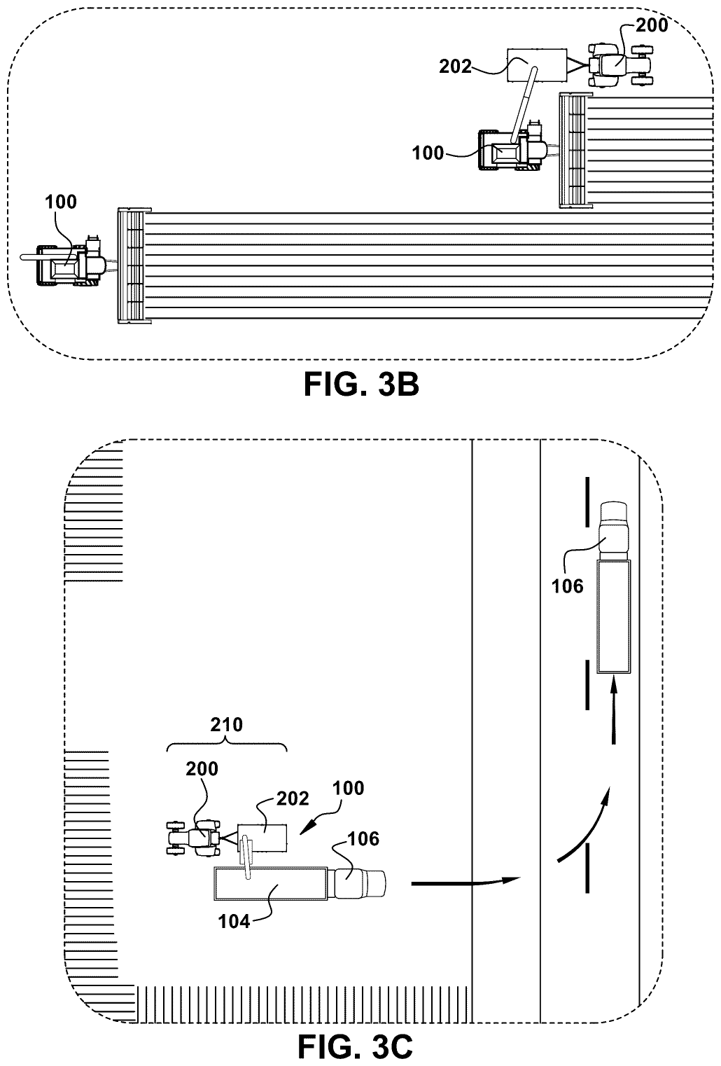

As can be seen in FIG. 1, and with reference also to FIGS. 3A-3C, agricultural machines 100, such as but not limited to multiple harvester vehicles, are operating in coordination (e.g., at the same time) within a harvest system 102 to harvest and haul away or offload harvested crop 104 using transport trucks 106 (e.g., semi-trailer truck with a bottom hopper trailer). It should be appreciated that one or more herein described examples maximize the overall productivity of the harvest system 102 that takes into consideration operations occurring within a field 108 (e.g., movement of harvester vehicles, weight of the carts, etc.), as well as operations occurring outside the field 108 (e.g., movement of transport trucks 106 on a road outside of the field 108 (e.g., a commercial roadway) or delivery of harvested crop to grain silos or elevators at a different location) to control speeds of the vehicles. In some examples, multiple agricultural machines operate in a network environment in accordance with an illustrative example that allows communication to a controller 110 (e.g., a control system or server remote from the field 108) using a network 112 (e.g., a network or wireless communication system).

In some examples, the controller 110 may be a single computer or a distributed computing cloud. The controller 110 is configured to support physical databases and/or connections to other external databases that store data as described herein used to control movement, particularly speed and braking, of the vehicles in and relative to the field 108. In the illustrative example, the harvester vehicles 100 operate on the field 108, which may be any type of land used to cultivate crops for agricultural purposes, which in the illustrated example includes a headland 114 and a work area 116.

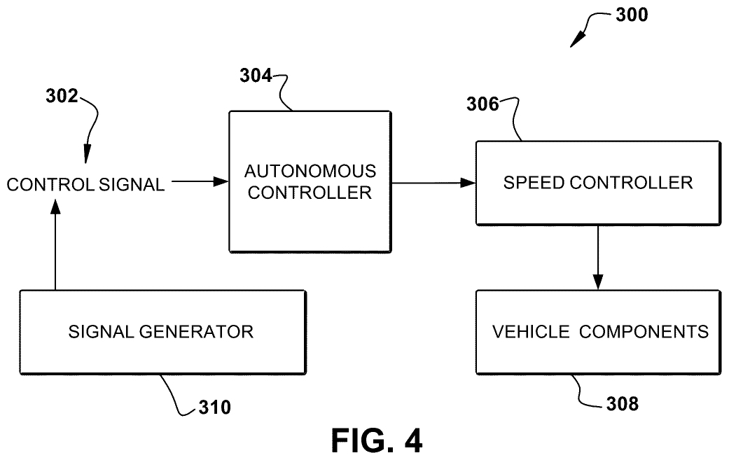

The agricultural machines include and/or operate with a speed control system 300 as illustrated in FIG. 4. In some examples, the speed control system 300 is configured as an autonomous speed and braking control system. The speed control system 300 includes an autonomous controller 304 configured to receive a control signal (e.g., a wireless speed control signal) and transmit the received signal to a speed controller 306. In some examples, the autonomous controller 304 processes or pre-processes the received signal before transmitting the signal to the autonomous controller 304. In some examples, the autonomous controller 304 is a transmission and reception device (e.g., a transceiver) that operates to communicate between the speed controller 306 (which in some example includes or is configured as a braking controller) and a signal generator 310 that generates the control signal 302. The signal generator 310 can be provided at different locations, such as at an autonomous control console located remote from the agricultural machines (e.g., in a farm building), in the cab of the agricultural machines (e.g., a cab of the tractor 200), etc. The signal generator 310 generates signals based on one or more inputs (e.g., a current weight of the cart 202) in some examples and automatically generates signals in other examples (e.g., based on feedback, to control a maximum vehicle speed and stop a vehicle).

The speed controller 306 in various examples is configured to control operation of one or more vehicle components 308 as described in more detail herein, which control the speed and/or braking of the agricultural machines. That is, the speed controller 306 receives the signals from the autonomous controller 304 and controls operation of one or more components of the agricultural machines to cause an acceleration force, a braking force, etc. to be applied to speed up, slow down, or stop the agricultural machines, which includes allowing autonomous vehicles to operate at higher speeds. It should be noted that in some examples, the speed controller 306 controls speed operation of different components of one or more vehicles. In some examples, the speed controller 306 controls speed and braking operation of in the tractor 200, as well as the cart 202 being towed by the tractor 200. It should also be noted that one or more components or operations of the speed control system 300 can be combined or separated and the functional/operational blocks in FIG. 4 are merely shown for example. For example, while the autonomous controller 304 is shown connected to the speed controller 306 and then to the vehicle components 308 in series, other configurations and connections are contemplated. For example, the autonomous controller 304 in some arrangements is configured to send a signal directly to the vehicle components 308. In this way, parallel signals can be output from the autonomous controller 304.

The speed control system 300 in some examples controls the agricultural machines to a maximum speed, to a speed range, etc. In one implementation, the speed control system 300 uses the known mass of the vehicle system 210 (e.g., the tractor 200 and cart 202) to control the maximum vehicle speed to ensure effective stopping distances. In one or more examples, the speed control system 300 uses the known mass and the equation energy=½*mass*velocity\hat{ }2 to determine how much energy the braking system of the vehicle has to dissipate and subsequently calculates the stopping distance given the braking capacity. The speed control system 300 then uses this calculation to limit the vehicle maximum velocity to meet stopping distance requirements. It should be noted that the mass or weight of the vehicle, including changes thereto, can be determined using different techniques (e.g., cart weight monitoring system).

As one example, a tractor is towing a grain cart (e.g., the tractor 200 and the cart 202) that is empty through the field. The grain cart has scales that are in communication with the tractor braking controller and the system also has access to information for the empty weights of both the tractor and the grain cart. The tractor also has a given braking capacity and in various examples a pre-programmed stopping distance is defined based upon the system requirements (e.g., braking or stopping requirements). With an empty grain cart, the tractor can travel faster in the field and maintain stopping distances. As the grain cart fills with weight, the maximum vehicle velocity limit is reduced in various examples as described herein to maintain the pre-defined stopping distance. It should be noted that other factors or data can be used as inputs to control speed and braking, such as terrain or slope data to compensate for attitude effects.

As another example, a combine with an empty grain tank is able to stop faster than one with a full grain tank, and as such the speed is limited to ensure the stopping distance requirement is met. As another example, the speed and braking control can be applied to a sprayer with an empty or full tank. In this example, weight data can be calculated using a measured volume of fluid and the density or specific gravity of the fluid. In another example, the speed and braking control can be applied to an air seeder with a commodity cart that measures the on-board commodity (e.g., weight of the seed). In another example, the speed and braking control can be applied to a planter that measures an on board commodity (e.g., weight of the plant material).

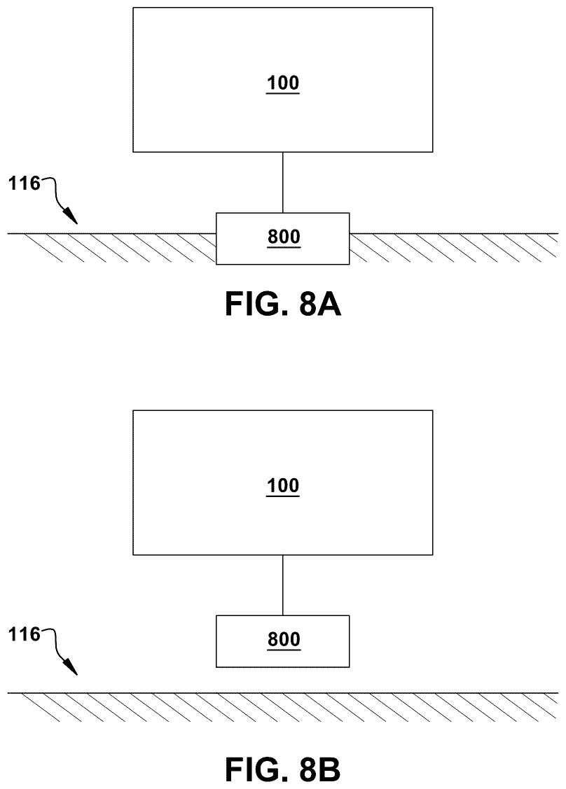

It should be noted that while the speed and braking control can be applied to vehicle systems 210 with dynamically changing weight as described herein, the speed and braking control can be utilized with devices that are ground engaging, such as ground engaging implements. For example, an implement 800 operatively connected to the agricultural machine 100 is shown in a ground engaging position in FIG. 8A and in a non-ground engaging position in FIG. 8B. If the implement 800 or vehicle system 210 is ground engaging, a faster speed is allowed due to the draft load generated by the implement 800 aiding in the stopping of the agricultural machine 100. The draft load may be dynamically changing. As such, the dynamically changing draft load may be one of the dynamically changing inputs from the vehicle system 210 to the controller 110. If the implement 800 is raised out of the ground to a non-ground engaging position, the speed and braking control (e.g., a speed and braking algorithm) may then revert to the weight based method of determining stopping distances. However, in most cases the ground engaging implement draft load may limit forward travel speed.

As described herein, dynamically changing mass changes at a faster speed at certain points of time, such as when the crop 104 is harvested into the container 202 or when the crop 104 is transported from the container 202 to the transport trucks 106. In other examples, the mass changes at a much slower speed and as such, the system does not have significant weight changes. In one nonlimiting example, the base weight of the vehicle system is used for the stopping distance/velocity limiting calculations. This base weight value is not measured dynamically in this example and may be a user entered value, a factory programmed value, a value communicated to the system on startup, etc. For example, the operator may add ballast to the vehicle system 210. For example, an implement has a base weight, and a tractor has a base weight, both of which are known values. When the implement is electronically connected to the tractor, the implement can communicate its weight to the speed control system 300, which then uses the combined system mass in performing the speed control and braking calculations as described herein. Additionally, on an implement configured with brakes, the braking capacity information can be communicated to the speed control system 300 and then used to calculate the speed limit based upon the predetermined stopping distance. Another example of a slower speed for dynamically changing mass is when the agricultural machine 100 is a tractor 202 pulling an empty grain cart 202. In such an example, the dynamically changing mass may be attributed to a tractor fuel tank, but the systems and methods described herein may still be utilized and found to be advantageous.

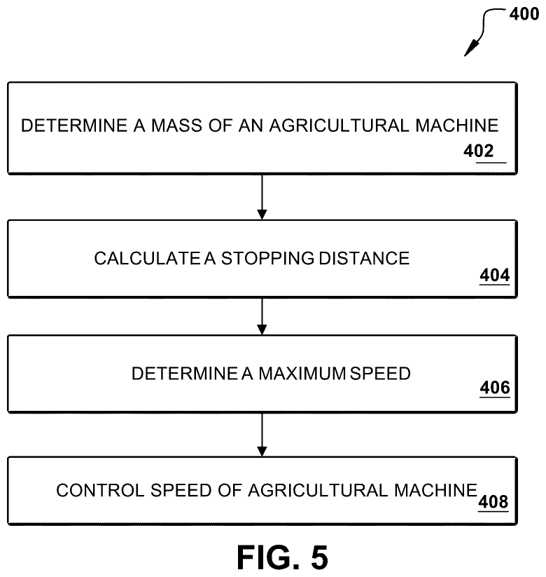

In various examples, improved speed control (and braking), particularly in autonomous agricultural machines, is provided, such as illustrated in the flowchart 400 of FIG. 5. It should be noted that different control schemes and arrangements are contemplated that allow for controlling speed and braking operation during different conditions of the vehicle system. That is, the flowchart 400 illustrates operations of a method involved in configuring a speed control and/or braking system, such as an autonomous speed control and brake system (e.g., the speed control system 300) to improve speed control and braking operation, particularly autonomous speed control and braking operation to optimize field operations. In some examples, the operations of the flowchart 400 are performed using one or more configurations described in more detail herein.

The flowchart 400 commences at 402, which includes determining a mass of an agricultural machine. As described herein, the mass can be determined using any method, which may include using a known weight or mass of the vehicle, a measured weight or mass, a user input weight or mass, etc. The mass value can be stored (and updated based on changes during operations as described herein) and can relate to one or more vehicles in a vehicle system. As an example, where the agricultural machine comprises, a tractor towing a grain cart, determining the mass includes determining a weight of a combination of the tractor and the grain cart including a contents of the grain cart. As described in more detail herein, this determination can include determining the weight of the contents using a measured volume of the grain cart and a density of the contents, or other measures. In some examples, a base weight of the agricultural machine is used as the determined mass, wherein the base weight is one of a user defined value, such as ballast added by an operator, a factory defined value, or a value received at a start-up of the agricultural machine

A stopping distance of the agricultural machine is calculated at 404 based on a braking capacity for the agricultural machine and using the determined mass of the agricultural machine. For example, as described herein, knowing the mass of the vehicle, the braking characteristics, or properties for the agricultural machine can be calculated. In some examples, the calculated distance is based in part on a desired or required stopping distance for a particular operation, application, etc., such as based on one or more conditions of a terrain, one or more conditions of one or more components of the agricultural machine, etc. As such, the stopping distance in some examples defines an effective stopping distance. In some examples, the stopping distance is a pre-programmed stopping distance based on a field operation being performed.

A maximum speed for the agricultural machine is determined at 406 based on the calculated stopping distance. For example, using the calculated stopping distance and other known factors that can affect braking, as described herein, the maximum speed for the agricultural machine is determined to ensure that the agricultural machine can stop within a desired or required stopping distance. The maximum speed can also be adjusted based on other factors, such as environmental conditions, operating conditions, etc. In some examples, the maximum speed for the agricultural machine is adjusted in response to a change in the determined mass of the agricultural machine, in response to a change in a position of an implement 800 aiding in a stopping of the agricultural machine, based on one or more harvesting tasks being performed, etc.

The speed of the agricultural machine is controlled at 408 to be below the maximum speed. For example, an alert can be provided when the agricultural machine is approaching (e.g., within a defined range of) the maximum speed. In some examples, the control signal 302 is sent to provide the alert. In another example, the control signal 302 may provide a recommended speed to an operator. Such recommended speed may be by means of a visual indicator viewable to an operator. The visual indicator may be constantly present. Further the visual indicator may display colors indicative of how close the speed of the agricultural machine at a point in time is to the maximum speed, such as a red, yellow, or green display. In one or more examples, the control signal 302 is used by the autonomous controller 304 to adjust a speed of the agricultural machine or cause the agricultural machine to slow down. In one or more examples, based on the control signal 302, and if the agricultural machine is not within a defined range of the maximum speed, the autonomous controller instructs or commands the agricultural machine to increase the vehicle speed. As should be appreciated, the control of the agricultural machine to be below the maximum speed can be performed using any suitable speed or braking control operation.

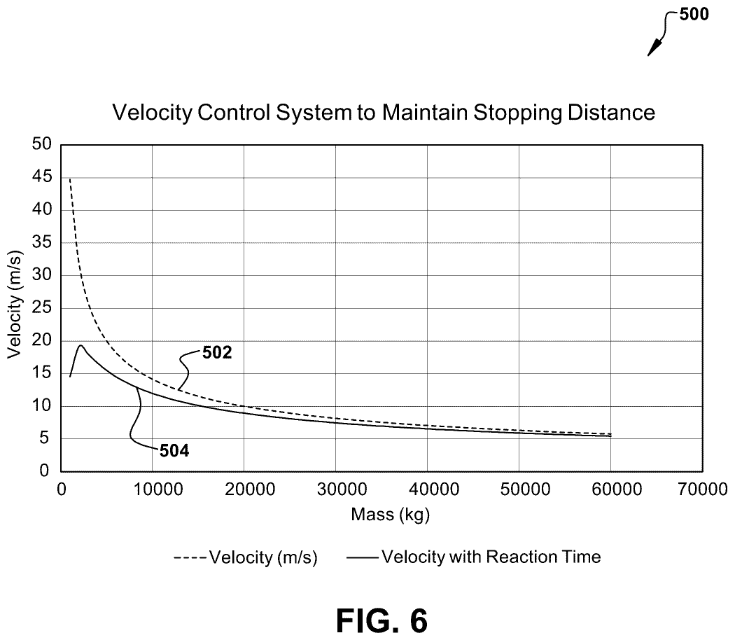

FIG. 6 illustrates a control scheme in one example. In particular, a graph 500 illustrates control curves 502 and 504 that can be used, for example, by the autonomous controller 304 to control the speed of the agricultural machine. The curve 502 represents a velocity control curve and the curve 504 represents a velocity control curve with reaction time (e.g., time to react to a condition or event). In the graph, the X-axis represents the mass of the agricultural machine and the Y-axis represents the velocity of the agricultural machine. In this example, the curves 502 and 504 are generated to maintain a desired or required stopping distance as described in more detail herein. That is, the curves 502 and 504 are used to control vehicle speed and braking to a maximum value as indicated by one the curves 502 and 504 to ensure a desired or required braking requirement is met. The curves 502 and 504 correspond to desired or required speed or velocity control profiles for a particular agricultural machine. It should be noted that other factors can be used in the calculations, such as adding slope or other calculations, which may change the curves 502 and 504. Also, as the mass of the agricultural machine changes, the curves 502 and 504 can be adjusted (e.g., shifted or otherwise changed) to maintain the desired or required braking requirement.

The curves represent a fixed braking capacity. This braking capacity, also known as deceleration rate, could be adjusted to different modes based upon factors such as presence or absence of an operator and/or a friction coefficient of the ground in which the agricultural machine operates.

In another implementation, these curves could also be dynamically learned on the agricultural machine by measuring the stopping distance (measured by wheel rotations, radar, GPS, or other sensing methods) and braking force applied from the beginning of applying the brakes until the agricultural machine reaches a desired slower speed or completely stops. In this mode, the system becomes more reactive versus predictive to update its model but may not require dynamic measurement of system weight. Additional factors such as attitude effects (i.e. vehicle orientation as in pitch, roll, yaw) could also be included in the model and dynamically updated as the agricultural machine traverses the field and attempts to stop.

In some examples, and with particular reference to the curve 504, the reaction time is a reaction time of a perception system (such as used in autonomous operations). The perception system may comprise at least one sensor 608 or a sensor array. The at least one sensor or sensor array may receive perception data. The perception data may dynamically change based on environment, such as fog conditions, weather conditions, changing topography and other conditions that may limit visibility. At higher travel speeds, this becomes more impactful than at lower speeds. To effectively manage stopping distances, the algorithm of one or more examples considers any time delays between detection of the need to stop and when the brakes are applied. As such, the curve 504 represents a first speed limit and the curve 504 is the adjusted speed limit after accounting for detection delays.

In one or more examples, the curves 502 and 504 are speed limits calculated as described in more detail herein and use one or more of the following: target stopping distance, perception system reaction time, stopping distance with reaction time, braking energy, braking force, mass, velocity, and velocity after accounting for reaction time, among others. The graph 500, in particular, is calculated based on the values in the table below.

TABLE 1

| Inputs | | | | | | Output | |
|---|---|---|---|---|---|---|---|
| | | Stopping | | | | | Velocity |
| | | Distance | | | | | after |
| Target | Perception | with | | | | | accounting |
| Stopping | System | Reaction | | Braking | | | for |
| Distance | Reaction | Time | Braking | Force | Mass | Velocity | reaction |
| (m) | Time (s) | (m) | Energy (J) | (N) | (kg) | (m/s) | time. |
| 50 | 1 | 5 | 1000000 | 20000 | 1000 | 45 | 15 |
| 50 | 1 | 18 | 1000000 | 20000 | 2000 | 32 | 19 |
| 50 | 1 | 24 | 1000000 | 20000 | 3000 | 26 | 18 |
| 50 | 1 | 38 | 1000000 | 20000 | 14000 | 12 | 10 |
| 50 | 1 | 38 | 1000000 | 20000 | 15000 | 12 | 10 |
| 50 | 1 | 39 | 1000000 | 20000 | 16000 | 11 | 10 |
| 50 | 1 | 39 | 1000000 | 20000 | 17000 | 11 | 10 |
| 50 | 1 | 39 | 1000000 | 20000 | 18000 | 11 | 9 |
| 50 | 1 | 42 | 1000000 | 20000 | 30000 | 8 | 7 |
| 50 | 1 | 42 | 1000000 | 20000 | 31000 | 8 | 7 |
| 50 | 1 | 42 | 1000000 | 20000 | 32000 | 8 | 7 |
| 50 | 1 | 43 | 1000000 | 20000 | 45000 | 7 | 6 |
| 50 | 1 | 43 | 1000000 | 20000 | 46000 | 7 | 6 |
| 50 | 1 | 43 | 1000000 | 20000 | 47000 | 7 | 6 |
| 50 | 1 | 44 | 1000000 | 20000 | 58000 | 6 | 6 |
| 50 | 1 | 44 | 1000000 | 20000 | 59000 | 6 | 5 |
| 50 | 1 | 44 | 1000000 | 20000 | 60000 | 6 | 5 |

In this example, the following equations are used, where E is kinetic energy, m is mas. V is velocity. W is weight. Fis force, and d is distance:

$$\begin{matrix}1. E = 1 / 2 mV \hat{} 2 \\ 2. W = F / d \\ 3. F / d = 1 / 2 mV \hat{} 2 \\ 4. ( 2 * d ( F / m ) ) \hat{} 0.5 = V\end{matrix}$$

Thus, speed and braking controls can thereby be provided using the calculated curves 502, 504.

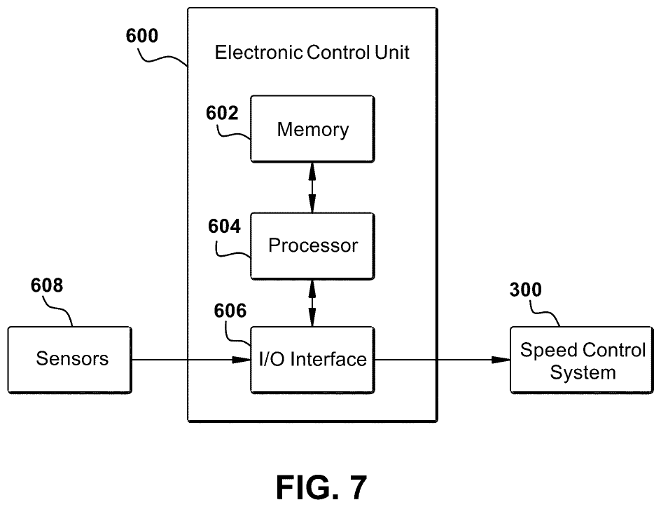

In one or more examples, an ECU 600 is configured to control various aspects of the operation of or forms part of one or more components (such as of the speed control system 300) as illustrated in FIG. 7. For example, the ECU 600 is configured for controlling the speed control system 300. The ECU 600 includes a plurality of electrical and electronic components that provide power, operational control, and protection to the components and modules within the ECU 600. In particular, the ECU 600 includes, among other things, an electronic processor 604 (e.g., a programmable microprocessor, microcontroller, or similar device), non-transitory, machine-readable memory 602, and an input/output interface 606. The electronic processor 604 is communicatively coupled to the memory 602. The electronic processor 604 is configured to retrieve from the memory 602 and execute, among other things, instructions related to the control processes and methods described herein, such as to control speed and braking by the speed control system 300. In some examples, the ECU 600 includes additional, fewer, or different components. The ECU 600 may also be configured to communicate with external systems including, for example, other components of the vehicle and/or operator controls.

The ECU 600 in the illustrated example is communicatively coupled to a plurality of sensors 608, which may be embodied as or include one or more sensors that measure the weight of a contents of a cart, a speed of a vehicle, receive data from the perception system etc. The ECU 600 in some examples receives a signal input from one or more of the sensors 608 indicative of, for example, a current load (weight) and is configured to adjust and/or control one or more components of the speed control system 300. The input/output interface 606 facilitates communication between the ECU 600 and the speed control system 300. Through the input/output interface 606, the ECU 600 is configured, for example, to control different settings of the speed control system 300 to obtain a desired or required sopping distance in some examples.

It should be noted that the memory 602 in some examples includes any computer-readable media. In one example, the memory 602 is used to store and access instructions configured to carry out the various operations disclosed herein. In some examples, the memory 602 includes computer storage media in the form of volatile and/or nonvolatile memory, removable or non-removable memory, data disks in virtual environments, or a combination thereof. In one example, the processor(s) 604 includes any quantity of processing units that read data from various entities, such as the memory 602. Specifically, the processor(s) 604 is programmed to execute computer-executable instructions for implementing aspects of the disclosure. In one example, the instructions are performed by the processor(s) 604 and the processor(s) 604 is programmed to execute instructions such as those to perform one or more operations discussed herein and depicted in the accompanying drawings.

Although described in connection with a particular computing device, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as implying that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A computerized system for controlling a speed of an agricultural machine, the computerized system comprising:
a vehicle system comprising:
the agricultural machine configured to perform an agricultural field operation; and
one or more of a container and an implement operably connected to the agricultural machine;
a controller configured to:
determine a mass of the vehicle system at a point in time, wherein the container comprises the mass that dynamically changes, wherein the implement comprises a draft load that dynamically changes;
calculate a stopping distance of the agricultural machine based on one or more of a braking capacity for the agricultural machine using the determined mass of the vehicle system and the draft load of the implement;
determine a maximum speed for the agricultural machine based on the calculated stopping distance; and
control the speed of the agricultural machine to be below the maximum speed and/or to provide a recommended speed to an operator.

2. The computerized system of claim 1, wherein the agricultural machine is one or more of a tractor, a harvester, a combine, a sprayer, an air seeder, and a planter; and
wherein the container is one or more of a grain cart, a grain tank, a grain wagon, a tank, a commodity cart, a commodity tank, an onboard container, and a fuel tank.

3. The computerized system of claim 1, wherein the container is configured to receive harvested crop from the agricultural machine and transport the harvested crop during the agricultural field operation.

4. The computerized system of claim 1, wherein the stopping distance comprises a pre-programmed stopping distance based on the agricultural field operation being performed.

5. The computerized system of claim 1, wherein the mass comprises a weight, the weight being a combination of the agricultural machine and the container, the container comprising contents of the container.

6. The computerized system of claim 5, wherein the weight of the contents comprises a measured volume of the container and a density of the contents.

7. The computerized system of claim 1, wherein the stopping distance comprises calculating an effective stopping distance.

8. The computerized system of claim 1, wherein the controller is configured to adjust a maximum speed for the agricultural machine in response to a change in the determined mass of the vehicle system.

9. The computerized system of claim 1, further comprising a perception system comprising at least one sensor with perception data, the perception data dynamically changing based on environment.

10. The computerized system of claim 1, wherein the implement comprises a ground engaging position and a non-ground engaging position, the controller configured to adjust a maximum speed for the agricultural machine in response to a change in a position of the implement;
wherein the controller configured to adjust the maximum speed to be a faster speed when the implement is in the ground engaging position; and
aiding in stopping the agricultural machine.

11. The computerized system of claim 1, wherein the dynamically changing mass changes at a faster speed and a slower speed, wherein the controller is configured to use a base weight of the vehicle system as the determined mass, wherein the base weight is one of a user defined value, a factory defined value, or a value received at a start-up of the agricultural machine when the dynamically changing mass changes at a slower speed.

12. The computerized system of claim 1, wherein the stopping distance of the agricultural machine is further based on one or more conditions of a terrain.

13. The computerized system of claim 1, wherein the stopping distance of the agricultural machine further based on one or more conditions of one or more components of the vehicle system.

14. The computerized system of claim 1, wherein the maximum speed for the agricultural machine is based on one or more harvesting tasks being performed.

15. The computerized system of claim 1, wherein the controller is configured to provide an alert to an operator that the controlled speed of the agricultural machine is approaching the maximum speed, wherein the alert may be one or more of an audible alert and a visual indicator.

16. The computerized system of claim 1, wherein the agricultural machine is an autonomous vehicle.

17. A system for controlling a speed of an autonomous agricultural machine, the system comprising:
a vehicle system configured to perform an agricultural operation in a field, the vehicle system comprising the autonomous agricultural machine and a container operably connected to the autonomous agricultural machine;
a controller configured to:
receive at least one or more dynamically changing inputs from the vehicle system;
calculate a stopping distance of the autonomous agricultural machine based on a braking capacity for the agricultural machine using the one or more dynamically changing inputs from the vehicle system;
determine a maximum speed for the autonomous agricultural machine based on the calculated stopping distance; and
control the speed of the autonomous agricultural machine to be below the maximum speed.

18. The system of claim 17, wherein the at least one or more dynamically changing inputs is a dynamically changing weight, the dynamically changing weight comprising a combination of the agricultural machine, the container, and contents of the container;
wherein the agricultural machine is one or more of a tractor, a harvester, a combine, a sprayer, an air seeder, and a planter; and
wherein the container is one or more of a grain cart, a grain wagon, a grain tank, a tank, a commodity cart, a commodity tank, an onboard container, and a fuel tank.

19. The system of claim 18, wherein the autonomous vehicle system comprises an implement operably connected to the agricultural machine, the implement having a ground engaging position and a non-ground engaging position;
wherein the at least one or more dynamically changing inputs is a dynamically changing draft load for the implement;
wherein the controller is configured to:
adjust the maximum speed for the agricultural machine in response to a change in a position of the implement;
adjust the maximum speed to be a faster speed when the implement is in the ground engaging position and a slower speed when the implement is the non-ground engaging position; and
aiding in stopping the agricultural machine.

20. A computerized system for controlling a speed of an autonomous agricultural machine, the system comprising:
a vehicle system comprising:
the autonomous agricultural machine configured to perform an agricultural field operation; and
one or more of a container and an implement operably connected to the agricultural machine;
a controller configured to:
determine one or more of a mass of the vehicle system at a point in time and a draft load of the vehicle system at a point in time, wherein the mass dynamically changes for the container or determine, wherein the draft load dynamically changes for the implement;
calculate a stopping distance of the autonomous agricultural machine based on a braking capacity for the autonomous agricultural machine using the determined mass of the vehicle system and contents of the container;
determine a maximum speed for the autonomous agricultural machine based on the calculated stopping distance;
control the speed of the autonomous agricultural machine to be below the maximum speed; and
aiding in stopping the autonomous agricultural machine;
a perception system comprising at least one sensor with perception data, the perception data dynamically changing based on environment; and
wherein the agricultural machine is one or more of a tractor, a harvester, a combine, a sprayer, an air seeder, and a planter;
wherein the container is one or more of a grain cart, a grain tank, a grain wagon, a tank, a commodity cart, a commodity tank, an onboard container, or a fuel tank; and
wherein the determined mass comprises a weight, the weight being a combination of the agricultural machine, the container, and contents of the container, the weight of the contents of the container comprises a measured volume of the container and a density of the contents.
